(19) United States
(12) Patent Application Publication
(10) Pub. No.: US 2018/0320025 A1
(43) Pub. Date: Nov. 8, 2018

(54) ADHESIVE COMPOSITIONS

(71) Applicant: HENKEL IP & HOLDING GMBH, Duesseldorf (DE)

(72) Inventors: Nigel SWEENEY, Dublin (IE); Brian DEEGAN, Dublin (IE); Lynnette HURLBURT, Manchester, CT (US); Andrew D. MESSANA, Newington, CT (US); Marc GALLIGAN, Dublin (IE)

(21) Appl. No.: 16/031,504

(22) Filed: Jul. 10, 2018

Related U.S. Application Data
(63) Continuation of application No. PCT/US2018/027907, filed on Apr. 17, 2018.
(60) Provisional application No. 62/488,354, filed on Apr. 21, 2017.

(51) Int. Cl. C09J 4/00; C09J 11/06; C09J 153/00

(52) U.S. Cl. CPC C09J 4/00; C08K 5/14; C09J 153/005; C09J 11/06

(57) ABSTRACT

The present invention provides adhesive compositions, sometimes in a two part configuration which include a first part containing a (meth)acrylate component, an organic peroxide and an acetal-containing free radically curable component and a second part containing a (meth)acrylate component, and benzoylthiourea derivatives or benzoylthiourethane derivatives.

### BACKGROUND

### Field

The present invention provides adhesive compositions, sometimes in a two part configuration which include a first part containing a (meth)acrylate component, an organic peroxide and an acetal-containing free radically curable component, and a second part containing a (meth)acrylate component, and benzoylthiourea derivatives or benzoylthiourethane derivatives.

### Brief Description of Related Technology

Acrylic-based adhesive compositions are well known. See e.g. U.S. Pat. No. 4,536,546 (Briggs). While adhesives based on this technology appear to have been sold under the tradename PLEXUS MA 300 and 310 by Illinois Tool Works Inc., Chicago, Ill., they can exhibit an obnoxious odor and they are toxic to handle, which are significant drawbacks to their use.

The first and second parts are of sufficiently low viscosity to be easily dispensed with a pumping apparatus. To form this adhesive, the first and second parts are mixed, and immediately after mixing, the mixture is of a higher viscosity, such that the adhesive does not sag, drip, or migrate, after application to a surface within the open time of the mixture, and the mixed first and second parts cure. By the term “open time” is meant the elapsed time between the mixture of the adhesive to the curing.

Recently, researchers at Henkel invented and developed a cure accelerator technology based on benzoylthiourea or benzoylthiourethane derivatives. U.S. Patent Application Publication No. US 2014/0004354 provides to that end a two part curable composition comprising:

Part A: one or more compounds within structures I or IA below:

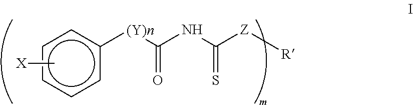

wherein Z is O or N—R, where R is selected from hydrogen, alkyl, alkenyl, aryl, hydroxyalkyl, hydroxyalkenyl, alkylene (meth)acrylate, carbonyl, carboxyl, or sulfonato, R′ is selected from hydrogen, alkyl, alkenyl, aryl, hydroxyalkyl, hydroxyalkenyl, alkylene (meth)acrylate, carbonyl, carboxyl, or sulfonato, or R and and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2, or

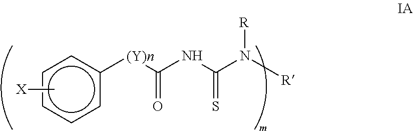

wherein R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, sulfonate, hydroxyl or haloalkyl; and Y is —SO₂NH—, —CONH—, —NH—, and —PO(NHCONHCSNH₂)NH—; and n is 0 or 1 and m is 1 or 2; and

Part B: an oxidant, where at least one of Part A or Part B comprises a (meth)acrylate component.

However, existing compositions do not possess the desired fast fixturing and good adhesion properties for the assembly of laminates, such as hand held display devices, coupled with the ability to enable debonding of substrates adhesively mated with the composition therebetween. A need exists for such compositions.

There is also a need for adhesive compositions that can form a robust bond on and/or between a variety of substrates, such as ink coated glass, composites and engineering plastics, that also have the ability to debond when required. In this way, should the end-user need to reuse, recycle or remove parts they may be so. For thermally activated debonding, temperatures below 100° C. are preferred so as to not damage the substrates.

The state of the art seemingly has not provided such adhesive compositions.

### SUMMARY

The present invention provides a solution to that need, and more.

The inventive adhesive compositions, sometimes in a two part configuration, include a first part (A) containing a (meth)acrylate component, an organic peroxide and an acetal-containing (meth)acrylate component and a second part (B) containing a (meth)acrylate component, and benzoylthiourea derivatives or benzoylthiourethane derivatives.

When the first and second parts are mixed and applied to at least one substrate to be adhesively mated, the composition will have up to 5 minutes of open time and when the substrates are mated they will show a fixture time of about 5 minutes of less at about room temperature (23° C.)

More specifically, a two part adhesive composition is provided that includes:
(a) a first part including a (meth)acrylate component, an organic peroxide and an acetal-containing free radically curable component; and
(b) a second part including a (meth)acrylate component, and benzoylthiourea derivatives or benzoylthiourethane derivatives.

In another aspect of the invention there is provided a method of preparing a two-part adhesive composition which includes:
(a) forming a first part (A) including a (meth)acrylate component, an organic peroxide and an acetal-containing free radically curable component; and
(b) forming a second part (B) including a (meth)acrylate component, and benzoylthiourea derivatives or benzoylthiourethane derivatives.

In yet another aspect, there is provided a method of bonding a first surface to a second surface, which includes the step of:

providing a two part composition which includes:
(a) a first part (A) including a (meth)acrylate component, an organic peroxide and an acetal-containing free radically curable component; and
(b) a second part (B) including a (meth)acrylate component, and benzoylthiourea derivatives or benzoylthiourethane derivatives;
   where when the first and second parts are mixed and applied to at least one substrate, the composition will have up to about 5 minutes of open time and when the substrates are mated they will have a cure time of about 20 minutes or less at 80° C. and a fixture time of less than 5 minutes.

In another aspect, the present invention there is provided an adhesive composition which includes:
(a) a (meth)acrylate component;
(b) a curative package comprising an organic peroxide, and benzoylthiourea derivatives or benzoylthiourethane derivatives; and
(c) an acetal-containing free radically curable component.

### DETAILED DESCRIPTION

The adhesive compositions of this invention provide enhanced adhesion to substrate surfaces constructed from a variety of materials, many of which are metallic.

The present invention therefore provides adhesive compositions, sometimes in a two part configuration which include a first part containing a (meth)acrylate component, an organic peroxide and an acetal-containing free radically curable component and a second part containing a (meth)acrylate component, and benzoylthiourea derivatives or benzoylthiourethane derivatives.

Among the substrates where enhanced adhesive and bonding strength is achieved are metal substrates, such as mild steel, stainless steel and aluminum, glass substrates (such as ink-coated glass substrates), and various plastic substrates (such as acrylics, polycarbonate, polycarbonate-ABS and nylon).

The combination of the Part (A) composition and the Part (B) composition results in a curable composition suitable for use in mating adhesively one substrate surface to another substrate surface. One or more of the substrates may be constructed to form an adhesive joint or a laminate. After curing, the reaction product of the composition is an adhesive bond between the two substrate surfaces.

While the two part compositions may be used in a variety of commercial applications,'they are particularly useful in the assembly of electronic display devices, such as hand-held phone and computer devices.

### Part (A)

### (Meth)acrylate Component

Any suitable material which contains at least one group having the following formula:

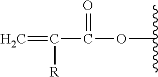

where R is selected from H, halogen, or C₁ to C₁₀ hydrocarbyl, may be used.

Advantageously, the group is a (meth)acryloxy group. The term “(meth)acryloxy” is intended to refer to both acrylate and methacrylate, in which R is H or methyl, respectively. The useful amount of the (meth)acrylate component typically ranges from about 20 percent by weight to about 80 percent by weight of the total composition. Desirably, the inventive compositions contain from about 50 percent by weight to about 70 percent by weight of (meth)acrylate component.

The (meth)acrylate component may be present in the form of a polymer, a monomer, or a combination thereof. When present in the form of a polymer, the (meth)acrylate component may be a polymer chain to which is attached at least one of the above-indicated groups. The groups may be located at a pendant or a terminal position of the backbone, or a combination thereof. Advantageously, at least two such groups may be present, and may be located at terminal positions. The (meth)acrylate component may have a polymer chain, constructed from polyvinyl, polyether, polyester, polyurethane, polyamide, epoxy, vinyl ester, phenolic, amino resin, oil based, and the like, as is well known to those skilled in the art, or random or block combinations thereof.

The polymer chain may be formed by polymerization of vinyl monomers. Illustrative examples of such vinyl monomers are methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, y-(meth)acryloyloxypropyltrimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentaacrylate, pentaerythritol triacrylate, ethoxylated trimethylolpropane triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate and ethoxylated bisphenol A di(meth)acrylate. These monomers may be used each alone or a plurality of them may be copolymerized. Particularly desirable (meth)acrylate ester monomers include those where the alcohol portion of the ester group contains 1-8 carbon atoms. For instance, 2-ethylhexyl methacrylate, hydroxyethyl methacrylate, cyclohexyl methacrylate, ethyl methacrylate, 1,3-butanedioldimethacrylate (BDMA), butyl methacrylate and methyl methacrylate (MMA), are examples.

Particularly desirable however is tetrahydrofurfuryl (meth)acrylate as at least a portion of the (meth)acrylate component.

The amount of the (meth)acrylate component used in the Part (A) composition may be from about 20 to about 95 percent by weight, such as about 40 to about 75 percent by weight.

### Acetal-Containing Free Radically Curable Component

As the acetal-containing free radically curable component, compounds within the general structure below may be used:

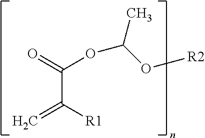

where R¹ is H, CH₃ or CN;

R² is a multivalent C₁ to C₈ alkyl chain, C₆ to C₁₂ aryl group or C₃ to C₈ cycloalkyl group; and

n is 1-4.

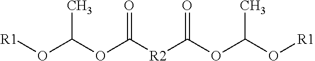

R² is a divalent unsaturated C₂-C₄₀ linkage (such as may be derived from a dicarboxylic acid selected from maleic acid, fumaric acid, itaconic acid, glutaconic acid, traumatic acid, glutinic acid and mesaconic acid.

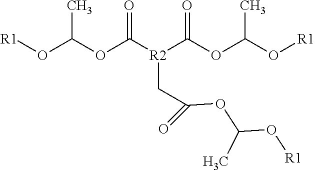

where R¹ is C₁ to C₈ alkyl, C₆ to C₁₂ aryl or C₃ to C₈ cycloalkyl; and

R² is a divalent unsaturated C₂-C₆₀ linkage (such as may be derived from a tricarboxylic acid selected from citric acid, isocitric acid, aconitic acid and trimesic acid).

Specific examples of the acetal-containing (meth)acrylate compound include those listed below:

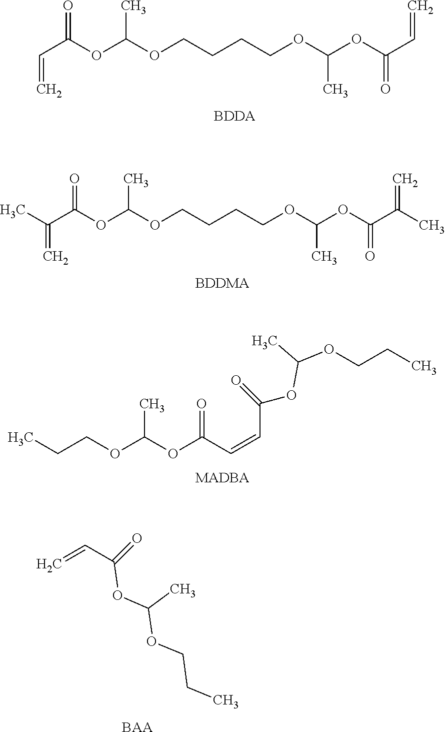

The amount of the acetal-containing (meth)acrylate compound used in the Part (A) composition may be from about 1 to about 20 percent by weight, such as about 2.5 to about 10 percent by weight.

### Peroxy Initiators

A class of peroxy initiators particularly suitable to the present invention is the hydroperoxy initiators. Of these, organic hydroperoxides are particularly. Particularly preferred organic hydroperoxides include, p-methane hydroperoxide, diisopropyl benzene hydroperoxide, pinene hydroperoxide, methyl ethyl ketone hydroperoxide, t-butyl-2-hydroxyethyl peroxide, t-butyl peroxymaleic acid, cumene hydroperoxide (CHP), tertiary-butyl hydroperoxide (TBH), and benzoyl peroxide (BP). Additionally, inorganic peroxides and compositions such as peroxy esters as for example t-butyl perbenzoate, benzophone peroxyesters and fluorenone peroxyesters, peroxy carbonates and halogen containing compounds having electronic structures which facilitate free radical formation, esters which decompose to form free radicals are also useful. The term “peroxy” is intended to mean peroxides, hydroperoxides and peresters which are suitable for preparing anaerobically curing system.

The peroxy polymerization initiators may be used in the Part (A) compositions in amounts sufficient to perform their initiation function. Useful, non-limiting amounts include about 0.25 percent by weight to about 10 percent by weight based on the total composition, and desirably about 1 percent by weight to about 3 percent by weight based on the total composition.

### Free Radical Inhibitors

Free radical polymerization inhibitors may be used in the present invention to prevent premature reaction prior to mixing.

Numerous suitable free-radical polymerization inhibitors are known in the art, and include quinones, hydroquinones, hydroxylamines, nitroxyl compounds, phenols, amines, arylamines, quinolines, phenothiazines, and the like. Particularly useful free radical inhibitors include hydroquinone, tertiary butylhydroquinone (“TBHQ”), methyl hydroquinone, hydroxyethylhydroquinone, phenothiazine, and NAUGARD-R (blend of N-alkyl substituted p-phenylenediamines, from Crompton Corp.). One or more individual free radical inhibitor components may also be combined.

The amount of the free radical inhibitor component used in the Part (A) composition may be from 0 to about 1 percent by weight, such as about 0.05 to 0.2 percent by weight.

### Part (B)

### (Meth)acrylate Component

The (meth)acrylate component used in part (B) may be any one or more of the (meth)acrylates used in part (A).

The amount of the (meth)acrylate component used in the Part (B) composition may be from about 20 to about 95 percent by weight, such as about 40 to about 75 percent by weight.

### Reactive Acid Component

The inventive compositions include an acid or acid ester. Desirably, this component is only in the Part (B) composition. Suitable acids or acid esters include phosphoric acid or derivatives, phosphate acid esters, and sulfonic acids or derivatives. A preferred reactive acid component is a phosphate acid ester.

The acid monomer is a free-radical polymerizable acid monomers, such as ethylenically unsaturated mono or polycarboxylic acids, maleic acid and crotonic acid. Desirable ones include methacrylic acid (“MAA”) and acrylic acid. The reactive acid component also modulates and decelerates the curing time of the thermoset composition.

Suitable phosphate esters include those represented by the formula:

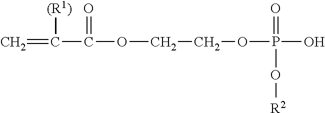

where here R¹ is H or CH₃, and R² is H, or a radical represented by the structure:

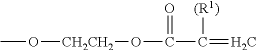

where R¹ is H or CH₃. A particularly useful phosphate ester is hydroxyl ethyl methacrylate (“HEMA”) phosphate ester, which is sold under the tradenames T-MULZ 1228 or HARCRYL 1228 or 1228M, each available from Harcross Chemicals, Kansas City, Kans. Also included are structures with at least one strong acid “active hydrogen” group, or with at least one phosphonic acid active hydrogen group (R₁R₂POOH), such as hydroxyl ethyl diphosphonic acid, phosphonic acid, and derivatives, or oligomeric or polymeric structures with phosphonic acid functionality or similar acid strength functionality.

The reactive acid component may be present from about 0.25 percent by weight to about 15 percent by weight of the total composition.

### Benzoylthiourea Derivatives or Benzoylthiourethane Derivatives

The benzoylthiourea derivatives or benzoylthiourethane derivatives may be within general structure I

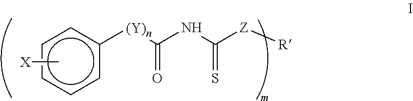

where Z is O or N—R, where R is selected from hydrogen, alkyl, alkenyl, hydroxyalkyl, hydroxyalkenyl, carbonyl, alkylene (meth)acrylate, carboxyl, or sulfonato, or R′ is a direct bond attaching to the phenyl ring; R′ is selected from hydrogen, alkyl, alkenyl, cycloalkyl, aryl, hydroxyalkyl, hydroxyalkenyl, alkylene- or alkenylene-ether, carbonyl, alkylene (meth)acrylate, carboxyl, nitroso or sulfonato; X is halogen, alkyl, alkenyl, hydroxyalkyl, hydroxyalkenyl, alkoxy, amino, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2.

A more specific general structure is shown below:

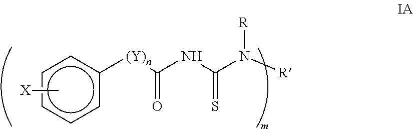

where R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2.

More specifically, the benzoylthiourea or benzoylthiourethane derivatives may be within structures II or IIA, respectively

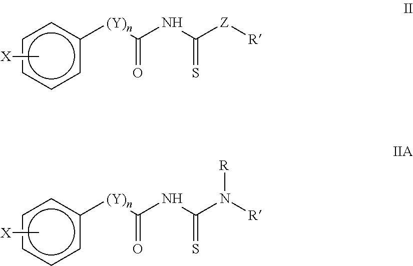

where R, R′, Z, X, Y, and n are as defined above.

More specific examples of the benzoylthiourea or benzoylthiourethane derivatives within structures II and IIA, respectively, are set forth below

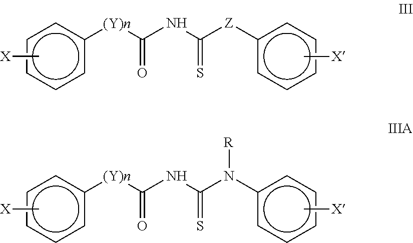

where R, X, Y, and n are as defined above, and X′ is defined as X.

Alternatively, the benzoylthiourea or benzoylthiourethane derivatives within structure I may be a bis version, where R′ is a linker. That is,

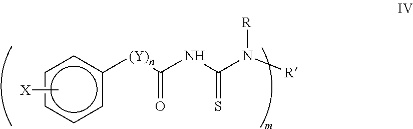

where R, R′, X, Y, and n are as defined above, and m is 2.

And even more specifically, the benzoylthiourea or benzoylthiourethane derivatives may be

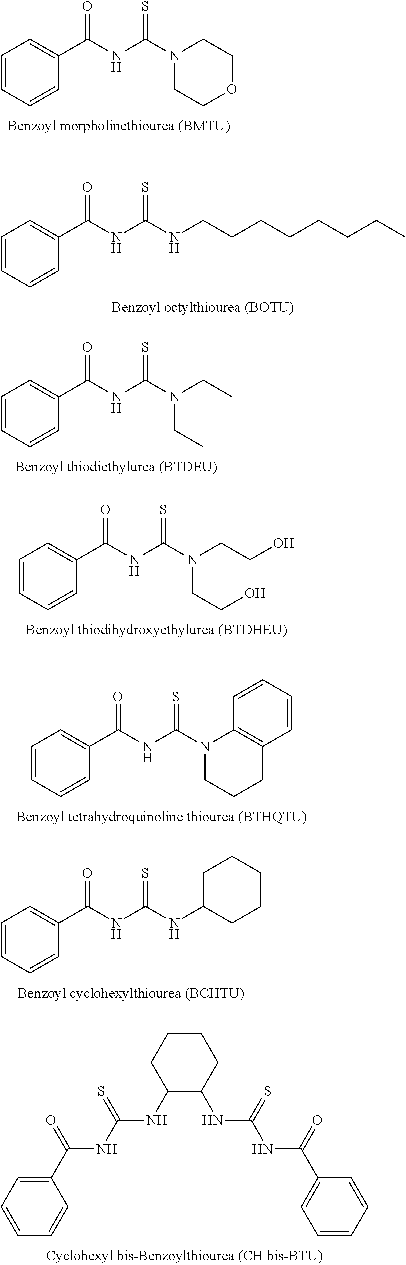

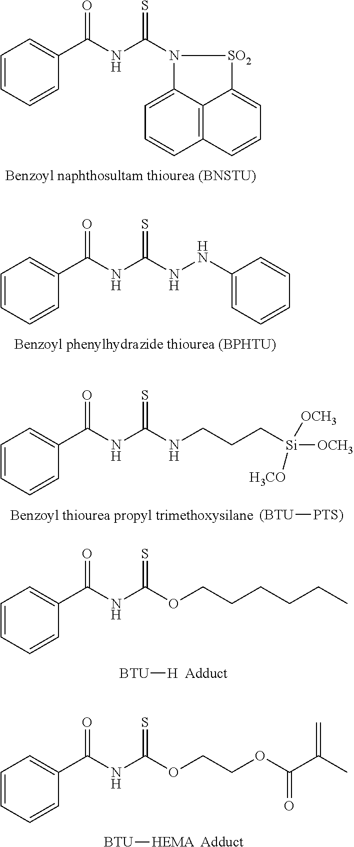

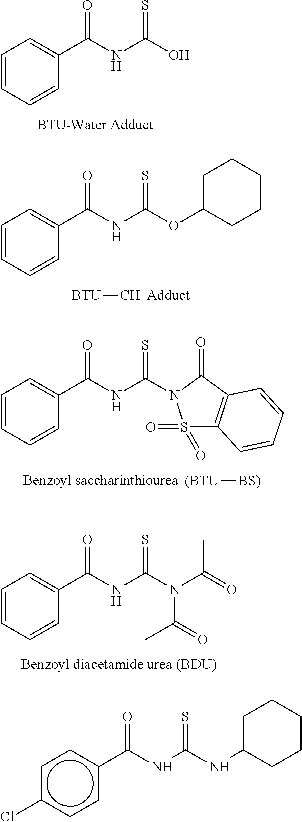

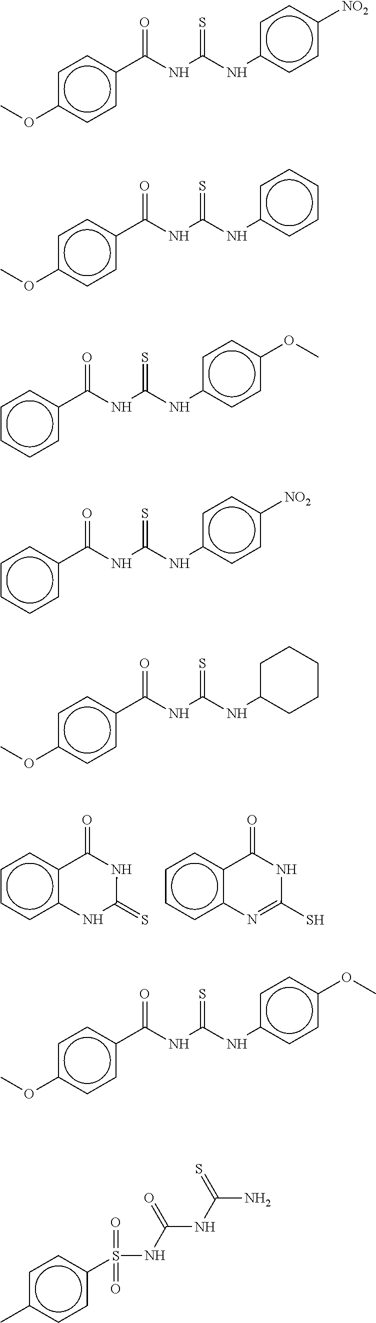

The benzoylthiourea or benzoylthiourethane derivatives may be employed in the adhesive compositions in amounts useful to enhance the adhesive properties of the compositions. For example, they may be present in amounts of about 0.25 percent by weight to about 10 percent by weight, such as about 1 percent by weight to about 5 percent by weight of the total composition.

### Constituents Used in Either or Both of Part (A) or Part (B)

### Plasticizers

Plasticizers may be used in either part or in both parts of the two part composition. Plasticizers may be any liquid or soluble compound that assists with the flexibility of the reactive portion of the composition and/or may act as a carrier vehicle for other components of the composition. Examples include aromatic sulfonamides, aromatic phosphate esters, alkyl phosphate esters, dialkylether aromatic esters, polymeric plasticizers, dialkylether diesters, polyglycol diesters, tricarboxylic esters, polyester resins, aromatic diesters, aromatic triesters (trimellitates), aliphatic diesters, epoxidized esters, chlorinated hydrocarbons, aromatic oils, alkylether monoesters, naphthenic oils, alkyl monoesters, paraffinic oils, silicone oils, di-n-butyl phthalate, diisobutyl phthalate, di-n-hexyl phthalate, di-n-hepytl phthalate, di-2-ethylhexyl phthalate, 7c,9c-phthalate (linear and branched), diisoctyl phthalate, linear 6c,8c,10c phthalate, diisononyl phthalate, linear 8c-10c phthalate, linear 7c-11c phthalate, diisodecyl phthalate, linear 9c-11c phthalate, diundecyl phthalate, diisodecyl glutarate, di-2-ethylhexyl adipate, di-2-ethylhexyl azelate, di-2-ethylhexyl sebacate, di-n-butyl sebacate, diisodecyl adipate, triethylene glycol caprate-caprylate, triethylene glycol 2-ethylhexanote, dibutoxyethyl adipate, dibutoxyethoxyethyl adipate, dibutoxyethoxyethyl formal, dibutoxyethoxyethyl sebacate, tri-2-ethylhexyl trimellitate, tri-(7c-9c(linear)) trimellitate, tri-(8c-10c(linear)) trimellitate, triethyl phosphate, triisopropyl phenyl phosphate, tributyl phosphate, 2-ethylhexyl diphenyl phosphate, trioctyl phosphate, isodecyl diphenyl phosphate triphenyl phosphate, triaryl phosphate synthetic, tributoxyethyl phosphate, tris(-chloroethyl) phosphate, butylphenyl diphenyl phosphate, chlorinated organic phosphate, cresyl diphenyl phosphate, tris(dichloropropyl) phosphate, isopropylphenyl diphenyl phosphate, trixylenyl phosphate, tricresyl phosphate, diphenyl octyl phosphate. Combinations of plasticizers are useful.

The amount of the plasticizer used in the composition as a whole may be from 0 to about 5 percent by weight, such as about 0.1 to about 1 percent by weight of the total composition.

### Block Copolymers

When used, the block copolymer may be any block copolymer capable of contributing to the physical properties desired for the disclosed composition. The block copolymers may be present in either or both parts of the two part composition.

The block copolymer rubber may be constructed using blocks of either butadiene or isoprene with styrene (for example, SBS, SIS, SEGS and SB), commercial examples of which are available from Shell Chemical Co. as KRATON D-1116 and other KRATON D-grade elastomers from Dexco as VECTOR 2411IP.

Other elastomers with Tg below about 25° C., which are soluble in methacrylate/acrylate monomers, can be used in place of the block copolymer rubbers. Examples of such are the homopolymer of epichlorohydrin and its copolymers with ethylene oxide, available from Zeon Chemicals as HYDRIN, acrylate rubber pellets, available from Zeon as HYTEMP, polyisoprene rubber, polybutadiene rubber, nitrile rubber, and SBR rubber (random copolymer of butadiene and styrene).

Still other block copolymers may be a styrene maleic anhydride copolymer, represented by the formula:

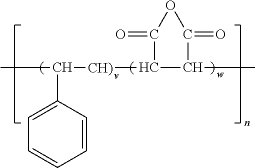

where v is from 1 to 12; w is from 1 to 6; and n is from 1 to 50.

Styrene maleic anhydride copolymers are well known and some of which are available commercially from Sartomer Company, Inc., Exton, PA under the trade name SMA EF80, for example. Styrene maleic anhydride copolymers represent the copolymerization product of styrene and maleib anhydride and are characterized by alternating blocks of styrene and maleic anhydride moieties.

Amphiphilic block copolymers may be particularly desirable. Arkema offers for sale commercially an amphiphilic block copolymer under the trademark NANOSTRENGTH. Such block copolymers are currently available in two versions: SBM and MAM. The SBM copolymer is reportedly made of polystyrene, 1,4-polybutadiene and syndiotactic poly(methyl methacrylate).

In addition, a polymer material constructed from polymethyl methacrylate (“PMMA”) and polybutyl acrylate (“PB”) may be used too. Polymer materials within this class are referred to as polymethylmethacrylate-block-polybutylacrylate-block polymethylmethacrylate copolymers (“MAM”).

As reported by Arkema, MAM is a triblock copolymer, consisting of about 70% PMMA and 30% PB. MAM is constructed from distinct segments, which provides for the ability to self-assemble at the molecular scale. That is, M confers hardness to the polymer and A confers elastomeric properties to the polymer.

A hard polymer segment tends to be soluble in (meth)acrylates, whereas the elastomeric segments provide toughness to the polymeric (meth)acrylate, which forms upon cure. MAM also reinforces mechanical properties, without compromising inherent physical properties. MAM is commercially available under the tradename NANOSTRENGTH, at present under several different grades i.e., E-21 and M-52N.

Arkema promotes the NANOSTRENGTH product line as an acrylic block copolymer that is miscible with many polymers, most of which according to the manufacturer are major industrial epoxy resins. See also U.S. Pat. No. 6,894,113 (Court), where in its abstract the '113 patent speaks to a thermoset material with improved impact resistance. The impact resistance is derived from 1 to 80% of an impact modifier comprising at least one copolymer comprising S-B-M, B-M and M-B-M blocks, where each block is connected to the other by a covalent bond or of an intermediary connected to one of the blocks by a covalent bond and to the other block by another covalent bond, M is a PMMA homopolymer or a copolymer comprising at least 50% by weight of methyl methacrylate, B is incompatible with the thermoset resin and with the M block and its glass transition temperature Tg is less than the operating temperature of the thermoset material, and S is incompatible with the thermoset resin, the B block and the M block and its Tg or its melting temperature is greater than the Tg of B.

Another commercially available example of an amphiphilic block copolymer is a polyether block copolymer known to the trade as FORTEGRA 100, from Dow Chemical Co. Dow describes FORTEGRA 100 as a low viscosity toughening agent designed for use as a high efficiency second phase, in amine cured epoxy systems. FORTEGRA 100 is reported to provide improved toughness without significantly affecting the viscosity, glass transition temperature, corrosion resistance, cure rate or chemical resistance of the final coating or composition. FORTEGRA 100 is also reported to be useful for formulation into standard bisphenol A and bisphenol F epoxy systems as it does not participate in the epoxy cure reaction. As a second phase toughening agent, FORTEGRA 100 is promoted as being effective when formulated at a specific volume fraction of the finish film or part, typically 3% to 8% by dry volume is said to achieve the toughening effect.

Additional block copolymers include those which comprise both hydrophobic and hydrophilic segments or portions, of the general formula:

—[(R¹)ᵥ—(R²)_{w}]ₙ—

where here R¹ is independently a hydrophobic olefin, such as ethylene, propylene, 1-butene, 1-hexene, 3-methyl-1-pentene, or 4-methyl-1-pentene or a polymerizable hydrophobic aromatic hydrocarbon such as styrene; each R² is a hydrophilic acid anhydride, such as maleic anhydride; v is from 1 to 12; w is from 1 to 6; and n is from 1 to 50.

The ratio of the hydrophobic segments to the hydrophilic segments in the styrene maleic anhydride block copolymer may be at least 2:1, such as between 3:1 and 12:1. The hydrophilic segments in the block copolymer should comprise an anhydride, such as maleic anhydride. The hydrophobic segments in the block copolymer should comprise at least one of ethylene, propylene, 1-butene, 1-hexene, 3-methyl-1-pentene, 4-methyl-1-pentene, or styrene. Desirably, the block copolymer should be prepared with the hydrophilic segments comprising maleic anhydride and the hydrophobic segments comprising styrene.

Reference to the following U.S. patent documents shows amphiphilic block copolymers suitable for use herein, and as such are incorporated herein by reference. U.S. Pat. No. 7,745,535 (Schmidt) is directed to and claims an amphiphilic multiblock copolymer where at least one block is a profiled block consisting of a) a hydrophilic middle block made from one or more monomeric units selected from acrylic acid, methacrylic acid, and the salts, esters, anhydrides and amides of acrylic acid and methacrylic acid; dicarboxylic acid anhydrides; carboxyethyl acrylate; and acrylamides; and b) hydrophobic end blocks where the multiblock copolymer is water insoluble, water indispersible, and not soluble or dispersible in C₁-3 alcohols.

U.S. Pat. No. 7,820,760 (Pham) is directed to and claims a curable adhesive epoxy resin composition including (a) an epoxy resin; (b) an amphiphilic block copolymer containing at least one epoxy resin miscible block segments and at least one epoxy resin immiscible block segments (where the immiscible block segment comprises at least one polyether structure provided that the polyether structure of the immiscible block segment contains at least one or more alkylene oxide monomer units having at least four carbon atoms); and (c) at least one curing agent. The amphiphilic block copolymer in the '760 patent is an all polyether block copolymer such as a PEO-PBO diblock copolymer or a PEO-PBO-PEO triblock copolymer. The amphiphilic block copolymer is present in an amount such that when in the '760 patent the epoxy resin composition is cured, the bond strength of the resulting cured epoxy adhesive resin composition increases compared to an epoxy resin composition without the amphiphilic polyether block copolymer.

U.S. Pat. No. 7,670,649 (Hoyles) is directed to and claims a curable ambient cure high-solids coating composition including (a) an epoxy resin; (b) an amphiphilic block copolymer containing at least one epoxy resin miscible block segment (where the immiscible block segment comprises at least one polyether structure provided that the polyether structure of the immiscible block segment contains at least one or more alkylene oxide monomer units) and at least one epoxy resin immiscible block segment; and (c) a sufficient amount of a nitrogen-containing curing agent to cure the coating composition at ambient temperature of less than about 60° C. When the epoxy resin composition is cured, the toughness of the resulting cured epoxy resin composition is increased.

U.S. Pat. No. 6,887,574 (Dean) is directed to and claims a curable flame retardant epoxy resin composition including (a) at least one flame retardant epoxy resin; (b) at least one amphiphilic block copolymer; and (c) a curing agent. Such components are present in the curable composition in the appropriate amounts and ratios such that, upon curing, the block copolymer self-assembles into a nano structure morphology, such as a worm-like micelle morphology. The resulting cured product is reported to have a remarkably increased high fracture resistance; and allows the use of flame retardant epoxies in applications where fracture resistance is an issue.

U.S. Patent Application Publication No. 2008/0287595 (Verghese) is directed to a composition comprising (1) a thermosettable resin selected from an epoxy resin, an epoxy vinyl ester resin, an unsaturated polyester resin or a mixture thereof, and (2) an amphiphilic mock copolymer dispersed in the thermosettable resin. In addition, fiber-reinforced plastics (FRP), coatings and composites prepared from the composition are provided as well.

International Patent Publication No. WO 2010/008931 (Turakhia) is directed to a structural composite that uses a block copolymer toughening agent to increase the fracture resistance (toughness) of the structural composite. The structural composite comprises (i) a carbon fiber reinforcing material and (ii) a thermosettable resin composition; wherein the thermosettable resin composition comprises (a) a thermosettable resin and (b) at least one block copolymer toughening agent.

International Patent Publication No. WO 2009/018193 (Verghese) is directed to curable compositions, cured compositions, and methods of forming the same, including an epoxy resin, a curing agent, an amphiphilic toughening agent, and an inorganic nanofiller, where the toughening agent forms a second phase having at least one dimension being on the nanometer scale.

The block copolymer may be used herein in an amount up to about 50 weight percent, desirably from 5 to 40 weight percent based on the total weight of the adhesive composition.

The glass transition temperature (“Tg”) of the block copolymer should be above about 40° C. In one embodiment, the Tg of the block copolymer is between about 40° C. and about 155° C.

The Tg of a polymer is the temperature at which the polymer becomes brittle on cooling or soft on heating. More specifically, Tg defines a pseudo second order phase transition in which a polymer yields, on cooling, a glassy structure with properties similar to those of a crystalline material. Above Tg, the polymer becomes soft and capable of plastic deformation without fracture. While the Tg is occasionally described as the “softening temperature” of a polymer, it is not uncommon for the polymer to begin softening at a temperature below the Tg. This is because, due to the nature of many non-crystalline polymers, the softening of the polymer may occur over a temperature range rather than abruptly at a single temperature value. Tg generally refers to the middle point of this range even though the polymer may begin to soften at a different temperature. For purposes of this application, the Tg of a polymer refers to the value as determined by ASTM E-1356.

The amount of the block copolymer used in the composition as a whole may be from about 5 percent by weight to about 75 percent by weight, such as about 10 percent by weight to about 50 percent by weight of the total composition.

### Other Additives

Either or both parts may contain additional additives, such as fillers, lubricants, thickeners, and coloring agents. The fillers provide bulk without sacrificing strength of the adhesive and can be selected from high or low density fillers. Also, certain fillers, such as silica, can confer rheological modification or small particle reinforcements. Commercially available examples include Cab-O-Sil 610 and AEROSIL R8200.

Of particular interest are low density fillers, because the resulting final product has an otherwise lower density than a product without the filler, yet has essentially the same strength characteristics as if the filler was not present.

Also, core shell polymers may be desirable. The core shell polymer is desirably a graft copolymer of the “core shell” type, or may also be a “shell-less” cross-linked rubbery particulate, such as acrylonitrile-butadiene-styrene (“ABS”), methacrylate-butadiene-styrene (“MBS”), and methacrylate-acrylonitrile-butadiene-styrene (“MABS”). BLENDEX 338 is an ABS powder from GE Plastics.

### Packaging and Mixing

When prepared in a two part format, each of Part (A) and Part (B) are packaged in separate containers, such as bottles, cans, tubes, or drums.

Part (A) and Part (B) are mixed in a ratio of about 1 to about 10 Part (a) to about 10 to about 1 Part (b). Desirably, the ratio of Part (A) to Part (B) is about 1 Part (A) to about 1 Part (B).

The mixing of the two parts can employ a mixing nozzle, which has fluid inputs for the two components, performs a suitable mixing operation, and dispenses the adhesive mixture directly onto the surface to be bonded. An example of a commercially available mixing and dispensing device is MIXPAC®, available from ConProTec, Salem, N.H. The two parts can also be mixed manually in a bowl, bucket, or the like, but the operator needs to ensure that the mixing is thorough. As an aid to ensuring that mixing is complete, each part can be formulated with a dye or pigment, so that after mixing, a third color is formed. For example, one part may have a yellow dye, the other part may have a blue dye, so that after mixing, the complete adhesive composition will be green.

The inventive compositions are excellent adhesives and sealants. On application to a first surface, such as a sheet of metal, fabric or plastic that can be incorporated into a laminated material, a second surface will be mated with the first surface and the two surfaces will be bonded together as the adhesive cures. A further advantage is that no surface preparation is required to bond clean substrates.

By the term “curing” is meant that the chemical reaction converting the fluid mix to the solid bond of this invention. The curing process of this composition is exothermic, and may reach a temperature of about 120° C. or so, when a large bead of adhesive is used.

After mixing, the adhesive compositions fully cure in about 20 minutes at about 80° C. and within about 24 hours at room temperature. Fixture times range from about 7 to about 10 minutes, at which time the bond will support a 3 Kg load.

### EXAMPLES

Initially, certain acetal-containing (meth)acrylates were synthesized as follows:

### Example A

### Preparation of 1-(4-[1-(prop-2-enoyloxy)ethoxy]butoxy)ethyl prop-2-enoate [butanediol diacetal diacrylate (“BDDA”)]

A 250 ml 3 neck round bottom flask was charged with 1,4 butanediol divinyl ether (50 ml, 0.32 mol) and methyl ether hydroquinone (0.302 g, 0.0024 mol), a stirrer bar and fitted with a reflux condenser, contact thermometer and dropping funnel. The reaction vessel was heated to a temperature of 80° C. and acrylic acid (46.1 g, 0.64 mol) was added dropwise with stirring as the reaction temperature was maintained at 80° C. for 5 hours. The solution was allowed to cool and was then washed with a saturated aqueous solution of sodium bicarbonate, followed by a washing with a brine solution. The remaining organic layer was dried over magnesium sulfate and dried under vacuum to leave a colourless oil. Yield: 63.47 g. IR analysis showed the —OH peak of the acrylic acid was no longer present.

### Example B

### Preparation of 1-[4-[1-(methylprop-2-enoyloxy)ethoxy]butoxy]ethyl methylprop-2-enoate [butanediol diacetal dimethacrylate (“BDDMA”)]

A 250 ml 3 neck round bottom flask was charged with 1,4 butanediol divinyl ether (50 ml, 0.32 mol) and methyl ether hydroquinone (0.302 g, 0.0024 mol), a stirring bar and fitted with a reflux condenser, contact thermometer and dropping funnel. The reaction vessel was heated to 80° C. and methacrylic acid (55.1 g, 0.64 mol) was added dropwise while the solution was stirred. The reaction vessel was maintained at a temperature of 80° C. for 5 hours, after which time the reaction mixture was allowed to cool to room temperature. The reaction mixture was thereafter washed with a saturated aqueous solution of sodium bicarbonate, followed by a washing with a brine solution. The remaining organic layer was dried over magnesium sulfate and dried under vacuum to leave a colourless oil. Yield: 67.23 g. IR analysis showed the —OH peak of the acrylic acid was no longer present.

### Example C

### Preparation of 1,4-bis(1-propoxyethyl) (2Z)-but-2-enediote [maleic acid dibutyl acetal (“MADBA”)]

A 250 ml 3 neck round bottom flask was charged with butanevinyl ether (50 ml, 0.39 mol) and methyl ether hydroquinone (0.302 g, 0.0024 mol), a stirrer bar and fitted with a reflux condenser, contact thermometer and dropping funnel. The reaction mixture was heated to 40° C. and maleic acid (68.44 g, 0.64 mol) dissolved in methanol (200 ml) was added dropwise while the solution was stirred. The temperature of the reaction vessel was maintained at 80° C. for 5 hours. The solution was allowed to cool and was then washed with a saturated aqueous solution of sodium bicarbonate, followed by a washing with a brine solution. The remaining organic layer was dried over magnesium sulfate and dried under vacuum to leave a colourless oil. Yield was 99.66g of product. IR analysis showed the —OH peak of the acrylic acid was no longer present.

### Example D

### Preparation of 1-propoxyethyl prop-2-enoate [butylacetal acrylate (“BAA”)]

A 250 ml 3 neck round bottom flask was charged with butanevinyl ether (50 ml, 0.39 mol) and methyl ether hydroquinone (0.302 g, 0.0024 mol), a stirrer bar and fitted with a reflux condenser, contact thermometer and dropping funnel. The flask contents was heated to 40° C. and acrylic acid (28.1 g, 0.39 mol) was added dropwise while the solution was stirred. The temperature of the contents of the vessel was maintained at 40° C. for 5 hours. The solution was allowed to cool and was then washed with a saturated aqueous solution of sodium bicarbonate, followed by a washing with a brine solution. The remaining organic layer was dried over magnesium sulfate and dried under vacuum to leave a colourless oil. Yield was 50.46 g of product. IR analysis of the product showed that the —OH peak of the acrylic acid was no longer present.

### Two-Part (Meth)acrylate Compositions

The following two part adhesive compositions were prepared as set forth in Table I below. The Part (A) composition was prepared by mixing together the components in the amounts (phr) as listed to form a homogeneous blend, using mixing speeds of about 2500 RPMs for about 2-3 minutes. The

Part (B) composition was similarly separately formed. The Part (A) composition was used without change throughout the examples.

TABLE 1
Part A

| Constituents | Wt. % |
|---|---|
| 30 wt. % Magnum 3904 | 82.5 |
| ABS Rubber in THFMA | |
| Methacrylic Acid | 10 |
| Cyclohexyl BTU | 5 |
| Hydrophobic Silica | 2.5 |

Table 2 below shows a list of the Part B compositions, which are otherwise the same save for the acetal-containing (meth)acrylate compound chosen and a control formulation (Part (B1)) without such a compound.

TABLE 2
Part B

| | B1 | B2 | B3 | B4 | B5 |
|---|---|---|---|---|---|
| Constituents | Wt. % | Wt. % | Wt. % | Wt. % | Wt. % |
| 30 wt % Magnum 3904 | 92.5 | 87.5 | 87.5 | 87.5 | 87.5 |
| ABS Rubber in THFMA | | | | | |
| Hydrophobic Silica | 2.5 | 2.5 | 2.5 | 2.5 | 2.5 |
| Cumene Hydroperoxide | 5 | 5 | 5 | 5 | 5 |
| BDDA | — | 5 | — | — | — |
| BDDMA | — | — | 5 | — | — |
| MADBA | — | — | — | 5 | — |
| BAA | — | — | — | — | 5 |

### Physical Properties/Performance

Table 3 below shows the results observed and recorded for tensile shear values obtained according to ASTM D3163 when using an adhesive formulation with a Part (B) Composition from Table 2 above. These Part (B) Compositions were mixed in equal parts by weight with the Part (A) Composition from Table 1.

Inked glass substrates were bonded to PC-ABS substrates with the Part (A)/Part (B) combinations mixed above.

To initiate debonding, the bonded lap shear substrates were placed in an oven at a temperature of 80° C. for 10 minutes after room temperature curing for 24 hours. After removal from the oven, the samples were allowed to cool under ambient conditions for 5 minutes before being evaluated for bond strength.

TABLE 3

| | Part B/Acetal Monomer | | | | |
|---|---|---|---|---|---|
| | B1 | B2 | B3 | B4 | B5 |
| Physical Property | None | BDDA | BDDMA | MADBA | BAA |
| Tensile Shear, 24 hour | 489 | 519 | 457 | 555 | 86 |
| cure at room temp (Psi) | | | | | |
| Tensile shear, 24 hour | 450 | 18 | 18 | 13 | 8 |
| cure at room temp and | | | | | |
| oven heating for 10 min | | | | | |
| at 80° C. (Psi) | | | | | |
| % reduction in bond | 9.2 | 96.5 | 97.1 | 97.7 | 90.7 |
| strengths post oven | | | | | |
| heating | | | | | |

The results shown in Table 3 demonstrate that inclusion of an acetal-containing (meth)acylate enables debonding of these bonded substrates after oven heating for 10 minutes at 80° C. compared to the control.

### Environmental Resistance

Ink coated glass substrates were bonded to PC-ABS substrates using these Part (A)/Part (B) combinations as above. After 24 hours of curing at room temperature. The bonded lap shears were stored in a humidity chamber for 10 days in an 85° C./95% relative humidity environment. The samples were evaluated after conditioning for a period of 1 hour under ambient conditions. Table 4 below shows the bond strengths after heat/humidity conditioning in comparison to bond strengths after 24 hour room temperature cure.

TABLE 4

| | Part B/Acetal Monomer | | | | |
|---|---|---|---|---|---|
| | B1 | B2 | B3 | B4 | B5 |
| Physical Property | None | BDDA | BDDMA | MADBA | BAA |
| Tensile Shear, 24 hour | 489 | 519 | 457 | 555 | 86 |
| cure at room temp (Psi) | | | | | |
| Tensile shear post 10 | 590 | 665 | 475 | 100 | 76 |
| days at 85° C./95% | | | | | |
| relative humidity | | | | | |

The results observed and recorded in Table 4 show that for the control (B1) and for the BDDA- and BDDMA-containing compositions (B2 and B3, respectively) tensile shear strength performance is comparable. However, the remaining compositions with the other acetal-containing (meth)acrylates (B4 and B5) there is a drop-off in tensile shear strength after the humid/heat ageing test.

BDDA-containing compositions demonstrated good performance under demanding environmental conditions. For instance, results of thermal cycling on bonded inked glass to PC-ABS lap shears are shown in Table 5.

Thermal cycle chamber parameters: 20 cycles of 25°/95% RH for 1.5 hours, ramped to 65°/95% RH for 4 hours, then ramped to 30° C./95% RH for 1.5 hours and left at 30° C./95% RH for 1 hour. Lap shear specimens were then removed and left at room temperature for 24 hours.

TABLE 5

| | Initial | Post Thermal Cycling |
|---|---|---|
| Part B | (psi) | (psi) |
| B1 (No acetal monomer) | 489 | 488 |
| B2 (5 wt. % BDDA) | 519 | 457 |

The results indicate that the debondable formulation shows good thermal cycling resistance.

What is claimed is:

1. An adhesive composition in a two part configuration comprising:
(a) Part (A) comprising a (meth)acrylate component, an organic peroxide and an acetal-containing free radically curable component; and
(b) Part (B) comprising a (meth)acrylate component, and benzoylthiourea derivatives or benzoylthiourethane derivatives.

2. The adhesive composition of claim 1, wherein the acetal-containing free radically curable component is represented by compounds within the general structure below: 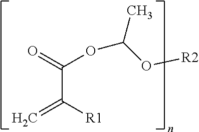
wherein R¹ is H, CH₃ or CN;
R² is a multivalent C₁ to C₈ alkyl chain, C₆ to C₁₂ aryl group or C₃ to C₈ cycloalkyl group; and
n is 1-4.

3. The composition of claim 1, wherein the acetal-containing free radically curable component is represented by compounds within the general structure below: 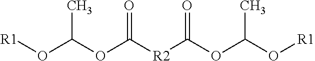
wherein R¹ is C₁ to C₃₀ alkyl, C₆ to C₃₀ aryl, ester, or carbamate; and
R² is a divalent unsaturated C₂-C₄₀ linkage (such as may be derived from a dicarboxylic acid selected from maleic acid, fumaric acid, itaconic acid, glutaconic acid, traumatic acid, glutinic acid and mesaconic acid.

4. The composition of claim 1, wherein the acetal-containing free radically curable component is represented by compounds within the general structure below: 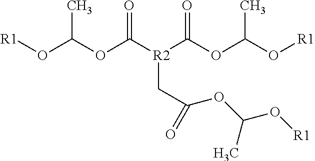
wherein R¹ is C₁ to C₈ alkyl, C₆ to C₁₂ aryl or C₃ to C₈ cycloalkyl; and
R² is a divalent unsaturated C₂-C₆₀ linkage.

5. The composition of claim 4, wherein R² of the acetal-containing free radically curable component is derived from a tricarboxylic acid selected from citric acid, isocitric acid, aconitic acid and trimesic acid.

6. The composition of claim 1, wherein the acetal-containing free radically curable component is represented by compounds selected from the group consisting of

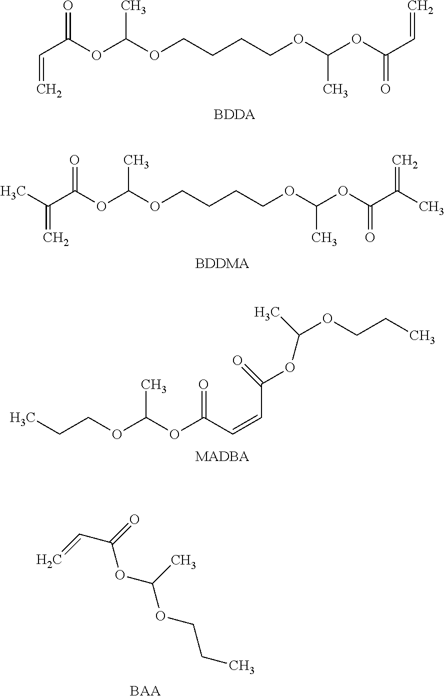

7. The composition of claim 1, wherein the (meth)acrylate component of at least one of the Part (A) or the Part (B) is selected from the group consisting of methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, y-(meth)acryloyloxypropyl trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, ethoxylated trimethylolpropane triacrylate, trimethylol propane trimethacrylate, dipentaerythritol monohydroxypentacrylate, pentaerythritol triacrylate, ethoxylated trimethylolpropane triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tri(propylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate, ethoxylated bisphenol A di(meth)acrylate, and combinations thereof.

8. The composition of claim 1, wherein the benzoylthiourea derivatives or benzoylthiourethane derivatives are represented by compounds within the general structure below: 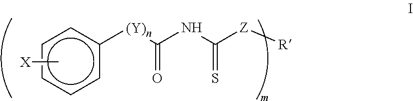
wherein Z is O or N—R, where R is selected from hydrogen, alkyl, alkenyl, hydroxyalkyl, hydroxyalkenyl, carbonyl, alkylene (meth)acrylate, carboxyl, or sulfonato, or R′ is a direct bond attaching to the phenyl ring; R′ is selected from hydrogen, alkyl, alkenyl, cycloalkyl, aryl, hydroxyalkyl, hydroxyalkenyl, alkylene- or alkenylene-ether, carbonyl, alkylene (meth)acrylate, carboxyl, nitroso or sulfonato; X is halogen, alkyl, alkenyl, hydroxyalkyl, hydroxyalkenyl, alkoxy, amino, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2; or 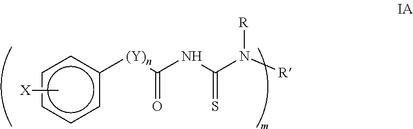
wherein R and R′ are independently selected from hydrogen, alkyl, alkenyl, aryl, hydroxyalkyl, hydroxyalkenyl, alkylene (meth)acrylate, carbonyl, carboxyl, or sulfonato, or R and R′ taken together form a carbocyclic or hetero atom-containing ring, or R′ is a direct bond attaching to the phenyl ring; X is halogen, alkyl, alkenyl, cycloalkyl, hydroxyalkyl, hydroxyalkenyl, alkoxy, amino, alkylene- or alkenylene-ether, alkylene (meth)acrylate, carbonyl, carboxyl, nitroso, sulfonate, hydroxyl or haloalkyl; and Y is —SO₂NH—, —CONH—, —NH—, and —PO(NHCONHCSNH₂)NH—; and n is 0 or 1 and m is 1 or 2.

9. The composition of claim 1, wherein the benzoylthiourea derivatives or benzoylthiourethane derivatives are represented by compounds within the general structure below: 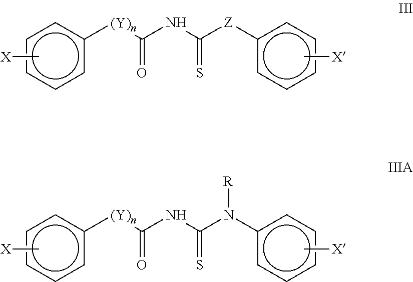
wherein R, X, Y, and n are as defined above, and X′ is defined as X.

10. The composition of claim 1, wherein the benzoylthiourea derivatives or benzoylthiourethane derivatives are represented by compounds within the general structure below: 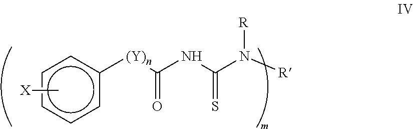
wherein R, R′, X, Y, and n are as defined above, and m is 2.

11. The adhesive composition of claim 1, further comprising a block copolymer.

12. A method of preparing a two-part adhesive composition comprising:
(a) forming Part (A) comprising a (meth)acrylate component, an organic peroxide and an acetal-containing free radically curable component; and
(b) forming Part (B) comprising a (meth)acrylate component, and benzoylthiourea derivatives or benzoylthiourethane derivatives.

13. A method of bonding a first surface to a second surface, comprising:
providing a two part composition comprising:
(a) Part (A) comprising a (meth)acrylate component, an organic peroxide and an acetal-containing free radically curable component; and
(b) Part (B)comprising a (meth)acrylate component, and benzoylthiourea derivatives or benzoylthiourethane derivatives.

14. The method of claim 13, wherein when Part (A) and Part (B) are mixed and applied to at least one substrate, the composition will have up to 5 minutes of open time and when the substrates are mated they will have a cure time of about 20 minutes or less at 80° C.; and a fixture time of less than 5 minutes at which the bond will support 3 Kg.

15. The method of claim 13, wherein Part (A) and Part (B) are mixed in a ratio of 1:10 to 10:1 Part (A) to Part (B) by volume.

16. An adhesive composition comprising:
(a) a (meth)acrylate component;
(b) a cure package comprising an organic peroxide and benzoylthiourea derivatives or benzoylthiourethane derivatives; and
(c) an acetal-containing free radically curable component.

17. The composition of claim 1, further comprising a reactive acid component.

18. The composition of claim 17, wherein the reactive acid component is (meth)acrylic acid.

19. The composition of claim 17, wherein the reactive acid component is sulphonic acid or sulphonic acid derivatives, phosphoric acid, phosphoric acid derivatives, and phosphate esters, or acrylic acid.
